(19) United States
(12) Patent Application Publication
(10) Pub. No.: US 2012/0113222 A1
(43) Pub. Date: May 10, 2012

(54) VIDEO SIGNAL PROCESSING APPARATUS, VIDEO SIGNAL PROCESSING METHOD, AND COMPUTER PROGRAM

(75) Inventor: Ryuhei Hata, Kanagawa (JP)

(73) Assignee: SONY CORPORATION, Tokyo (JP)

(21) Appl. No.: 13/286,303

(22) Filed: Nov. 1, 2011

(30) Foreign Application Priority Data
Nov. 8, 2010 (JP) P2010-249809

(51) Int. Cl. H04N 13/00

(52) U.S. Cl. 348/43; 348/E13.064

(57) ABSTRACT

A video signal processing apparatus includes a correction pixel determining unit configured to detect an edge and a background region of a left-eye image and a right-eye image so as to determine a pixel that is to be corrected, a correction amount map forming unit configured to calculate a correction amount for each pixel based on whether the pixel is determined as a correction pixel, so as to form a correction amount map of a screen, and an image correcting unit configured to add the correction amount map to each of the left-eye image and the right-eye image that are inputted, so as to obtain a correction image.

### CROSS-REFERENCE TO RELATED APPLICATION

The present application claims priority from Japanese Patent Application No. JP 2010-249809 filed in the Japanese Patent Office on Nov. 8, 2010, the entire content of which is incorporated herein by reference.

### BACKGROUND

The present technology relates to a video signal processing apparatus, a video signal processing method, and a computer program by which a stereoscopic video image composed of a left-eye video signal and a right-eye video signal is processed. Especially, the present technology relates to a video signal processing apparatus, a video signal processing method, and a computer program by which contrast correction is performed with respect to a stereoscopic video image.

A stereoscopic video image which seems three-dimensional for an observer can be provided by displaying video images having parallax with respect to right and left eyes of the observer. As one of methods for providing a stereoscopic video image, there is a method in which an observer puts on glasses having a special optical property and images with parallax are shown with respect to both eyes.

For example, a time-division stereoscopic video image display system is composed of a display device which displays a plurality of video images different from each other in a time-division manner and shutter glasses which are worn by an observer of the video images. The display device alternately displays a left-eye video image and a right-eye video image having parallax on a screen in a particularly short cycle. On the other hand, the shutter glasses worn by the observer include shutter mechanisms which are composed of liquid crystal lenses and the like respectively provided to a left-eye part and a right-eye part. In the shutter glasses, the left-eye part of the shutter glasses transmits light and the right-eye part blocks the light while a left-eye video image is displayed. Further, the right-eye part of the shutter glasses transmits light and the left-eye part blocks the light while a right-eye video image is displayed. That is, a stereoscopic video image is provided to the observer such that the display device displays a left-eye video image and a right-eye video image in a time-division manner and the shutter glasses performs image selection by its shutter mechanisms in synchronization with display switch performed by the display device.

A left-eye video image and a right-eye video image are commonly taken by two cameras. In this case, contrast difference between the right and left video images should be decreased by setting both cameras' settings (types of lenses, apertures, properties of imaging elements, and the like) to be same. This is because if same video images are not displayed on right and left, produced image is to be seen flickering when the images are displayed alternately, generating adverse effects such as degradation of image quality and difficulty in looking.

For example, a stereoscopic video imaging apparatus which synchronizes focuses, apertures, and gains of imaging units of a left camera and a right camera with each other is proposed (for example, refer to Japanese Unexamined Patent Application Publication No. 8-242468). However, this system uses a dedicated camera, increasing cost.

When the present inventor and the like image-analyzed stereoscopic video images which were actually broadcasted, it was found that there were some cases that brightness of a right image and brightness of a left image were different from each other and thus brightness and contrast of two cameras were not adjusted.

Image contrast correction is performed commonly by correcting a gamma curve expressing a so-called gamma characteristic. Such method is widespread that a gamma curve is produced based on a measurement result of a histogram of image brightness and a measurement result of an average picture level (APL) and contrast correction is performed by using the produced gamma curve (For example, refer to Japanese Unexamined Patent Application Publication No. 2007-336530).

For example, a stereoscopic video signal processing apparatus which detects a histogram of each of a left video image and a right video image for every frame and corrects one video signal so as to reduce difference is proposed (For example, refer to Japanese Unexamined Patent Application Publication No. 2007-151125).

However, if contrast correction is performed with respect to a stereoscopic video image by using average brightness of the whole screen, the following problems arise.

(1) A correction amount of the whole screen is affected by brightness difference of a part of an object which is displayed on a screen.

(2) Though it is natural that there is parallax on an edge part of the object, a part having parallax is corrected, adversely affecting stereoscopic view.

(3) An image is affected by brightness difference caused by an illuminated way and reflection of a shooting object. For instance, a part in which brightness is different between right and left due to reflected light from a water surface is also corrected, making the whole screen whitish.

### SUMMARY

It is desirable to provide superior video signal processing apparatus, video signal processing method, and computer program by which correction processing of brightness difference and contrast correction processing can be favorably performed with respect to a stereoscopic video image composed of a left-eye video signal and a right-eye video signal.

Further, it is desirable to provide superior video signal processing apparatus, video signal processing method, and computer program by which correction of brightness difference and contrast correction are performed with respect to a stereoscopic video image without adversely affecting a stereoscopic effect so as to favorably eliminate a flickering effect.

A video signal processing apparatus according to a first embodiment of the present technology includes a correction pixel determining unit configured to detect an edge and a background region of a left-eye image and a right-eye image so as to determine a pixel that is to be corrected, a correction amount map forming unit configured to calculate a correction amount for each pixel based on whether the pixel is determined as a correction pixel, so as to form a correction amount map of a screen, and an image correcting unit configured to add the correction amount map to each of the left-eye image and the right-eye image that are inputted, so as to obtain a correction image.

According to a second embodiment of the present technology, the video signal processing apparatus of the first embodiment further includes a correction amount filtering unit configured to apply a low pass filter to the correction amount map formed by the correction amount map forming unit. In the video signal processing apparatus, the image correcting unit uses the correction amount map obtained after applying the low pass filter.

According to a third embodiment of the present technology, the correction amount filtering unit of the video signal processing apparatus of the second embodiment includes at least one of a two-dimensional low pass filter that is applied to an inside of the screen and a low pass filter that is applied in a time direction.

According to a fourth embodiment of the present technology, the video signal processing apparatus further includes an image enhancing unit configured to give enhancement to the left-eye image and the right-eye image that are obtained after corrected by the image correcting unit of the video signal processing apparatus of the first embodiment.

According to a fifth embodiment of the present technology, the correction pixel determining unit of the video signal processing apparatus of the first embodiment calculates brightness difference between the left-eye image and the right-eye image, and when the brightness difference is larger than a predetermined threshold value, the correction pixel determining unit determines that a part on which the brightness difference is larger than the predetermined threshold value is an edge part.

According to a sixth embodiment of the present technology, the correction pixel determining unit of the video signal processing apparatus of the first embodiment performs measurement for a predetermined number of frames and determines a region having small change as the background region.

According to a seventh embodiment of the present technology, the correction pixel determining unit of the video signal processing apparatus of the first embodiment decreases a correction gain on the edge part and increases a correction gain of the background region.

According to an eighth embodiment of the present technology, the correction amount map forming unit of the video signal processing apparatus of the first embodiment calculates difference between brightness of the left-eye image and brightness of the right-eye image and multiplies the difference by the correction gain determined by the correction pixel determining unit so as to obtain a correction amount.

A video signal processing method according to a ninth embodiment of the present technology includes detecting an edge and a background region of a left-eye image and a right-eye image so as to determine a pixel that is to be corrected, calculating a correction amount for each pixel based on whether the pixel is determined as a correction pixel, so as to form a correction amount map of a screen, and adding the correction amount map to each of the left-eye image and the right-eye image that are inputted, so as to obtain a correction image.

A computer program, according to a tenth embodiment of the present technology, that is written in a computer readable form and is used to make a computer function as a correction pixel determining unit configured to detect an edge and a background region of a left-eye image and a right-eye image so as to determine a pixel that is to be corrected, a correction amount map forming unit configured to calculate a correction amount for each pixel based on whether the pixel is determined as a correction pixel, so as to form a correction amount map of a screen, and an image correcting unit configured to add the correction amount map to each of the left-eye image and the right-eye image that are inputted, so as to obtain a correction image.

The computer program according to the tenth embodiment is a definition of a computer program that is written in the computer readable form so as to realize predetermined processing on a computer. In other words, by installing the computer program of the tenth embodiment into a computer, a coactive effect is exerted on the computer. Thus, a similar advantageous effect to that of the video signal processing apparatus of the first embodiment can be obtained.

According to the embodiments of the present technology, superior video signal processing apparatus, video signal processing method, and computer program by which brightness difference correction and contrast correction can be performed with respect to a left-eye video signal and a right-eye video signal without adversely affecting a stereoscopic effect and can favorably eliminate a flicker effect can be provided.

According to the embodiments of the present technology, flicker between a left-eye image and a right-eye image is reduced by performing brightness difference correction and contrast correction with respect to a stereoscopic video image, and thus image quality can be improved. Further, an image which can be easily viewed in a three-dimensional manner can be obtained by reducing flicker between the left-eye image and the right-eye image.

According to the embodiments of the present technology, a correction amount is determined in each pixel, so that contrast correction processing which is not affected by the illuminated way and reflection of a shooting object can be realized.

According to the embodiments of the present technology, correction is performed in a concentrated manner in a background region which affects the flicker effect while avoiding correcting an edge part which affects parallax. Accordingly, brightness difference and contrast of a stereoscopic video image can be corrected without adversely affecting the stereoscopic effect.

Other purposes, features, and advantageous effects of the embodiments of the present technology will be shown in a later-described embodiment and a detailed description based on the accompanying drawings.

### BRIEF DESCRIPTION OF THE DRAWINGS

FIG. 1 schematically illustrates the configuration of a stereoscopic video image display system according to an embodiment of the present technology;

FIG. 2 illustrates a control operation of shutter glasses in an L sub-frame period;

FIG. 3 illustrates a control operation of the shutter glasses in an R sub-frame period;

FIG. 4 is a block diagram schematically showing the functional configuration for correcting brightness difference and a contrast of a stereoscopic video image in a video signal processing unit; and

FIG. 5 is a flowchart showing a processing procedure for correcting brightness difference and a contrast of a stereoscopic video image in the video signal processing unit.

### DETAILED DESCRIPTION OF EMBODIMENTS

An embodiment of the present technology is described below in detail in reference to the accompanying drawings.

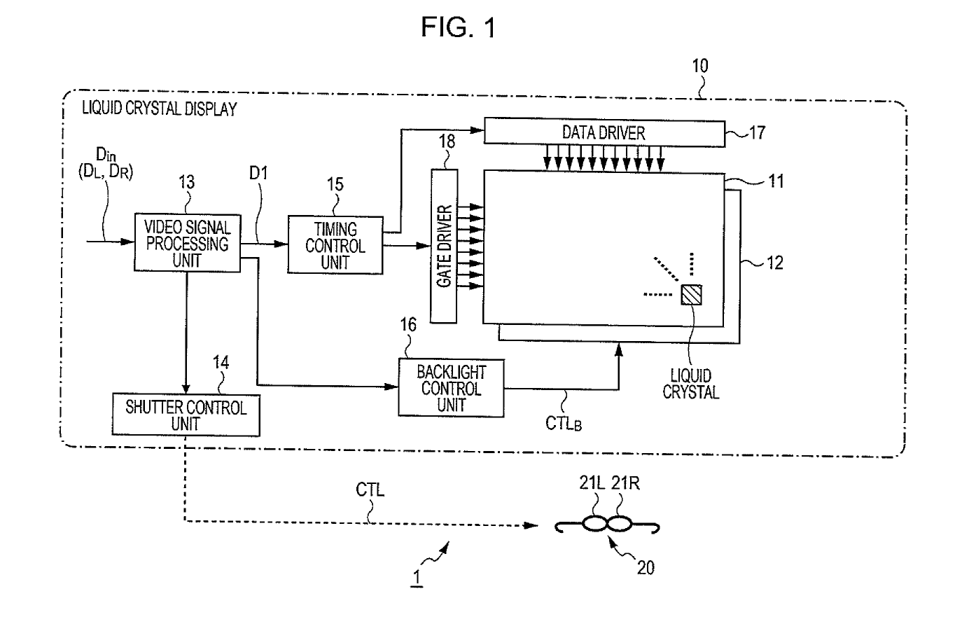

FIG. 1 schematically illustrates the configuration of a stereoscopic video image display system 1 according to the embodiment of the present technology. The stereoscopic video image display system 1 shown in FIG. 1 includes a liquid crystal display 10 which displays a left-eye video image L and a right-eye video image R alternately on a screen in a particularly short cycle and shutter glasses 20 that an observer puts on.

The liquid crystal display 10 includes a liquid crystal display panel 11, a backlight 12, a video signal processing unit 13, a shutter control unit 14 which controls opening/closing timing of a shutter mechanism of the shutter glasses 20, a timing control unit 15, a backlight control unit 16, a data driver 17, and a gate driver 18. In the embodiment, the liquid crystal display 10 displays and outputs a video image based on an input video signal Din including a right-eye video signal DR and a left-eye video signal DL which have right and left parallax.

The liquid crystal display panel 11 is an active matrix type in which TFTs are arranged in respective pixels, for example. The backlight 12 is a light source which radiates light to the liquid crystal display panel 11. The backlight 12 is controlled so as to switch a lighting-up (light emitting) operation and a lighting-down operation in a time-division manner based on a control signal CTLB which is supplied from the backlight control unit 16.

As the backlight 12, a light emitting diode (LED), a cold cathode fluorescent lamp (CCFL), or the like, for example, may be used. If a CCFL is used, afterglow is easily generated, and at the same time, afterglow properties of respective colors of RGB are different from each other.

The liquid crystal display panel 11 includes a plurality of pixels which are arranged in matrix as a whole. Further, the liquid crystal display panel 11 modulates light which is emitted from the backlight 12 based on a video voltage supplied from the data driver 17, in accordance with a driving signal supplied from the gate driver 18, so as to perform a video image display which is based on an input video signal Din. In the embodiment, the liquid crystal display panel 11 alternately displays a right-eye video image R based on a right-eye video signal DR and a left-eye video image L based on a left-eye video signal DL in a time-division manner, within a predetermined cycle such as one frame.

The video signal processing unit 13 controls an order of writing the right-eye video signal DR and the left-eye video signal DL in the liquid crystal display panel (that is, a displaying order) based on the input video signal Din so as to generate a video signal with respect to the liquid crystal display panel 11. In the embodiment, the video signal processing unit 13 generates a video signal D1, in which left-eye video signals DL and right-eye video signals DR are alternately arranged within one frame period, from the input video signal Din. Here, in the following description, a display period of the left-eye video image L in one frame period is referred to as an “L sub-frame period” and a display period of the right-eye video image R in the one frame period is referred to as an “R sub-frame period”.

Further, the video signal processing unit 13 corrects brightness and distortion of lenses, difference in light amounts depending on camera positions, and the like with respect to the left-eye video image and the right-eye video image so that the same video images are displayed on the right and the left. Furthermore, the video signal processing unit performs image quality correction such as brightness difference correction, contrast correction, and contour correction with respect to each of the left-eye video image and the right-eye video image.

The timing control unit 15 controls driving timing of the gate driver 18 and the data driver 17 and supplies the video signal D1 supplied from the video signal processing unit 13 to the data driver 17. The timing control unit 15 may perform overdrive processing with respect to the video signal D1.

The gate driver 18 sequentially drives each of the pixels in the liquid crystal display panel 11 along a gate line in accordance with the timing control by the timing control unit 15.

The data driver 17 supplies a video voltage based on the video signal D1 supplied from the timing control unit 15, to each of the pixels of the liquid crystal display panel 11. Specifically, the data driver 17 performs D/A conversion with respect to the video signal D1 so as to generate an analog video signal corresponding to a video voltage and output the analog video signal to each of the pixels.

The shutter control unit 14 outputs a timing control signal CTL for controlling opening/closing switch of right and left shutter mechanisms, to the shutter glasses 20. The timing control signal CTL corresponds to output timing of the right-eye video signal DR and the left-eye video signal DL outputted by the video signal processing unit 13.

The shutter glasses 20 is worn by an observer (not shown in FIG. 1) of the liquid crystal display 10, enabling stereoscopic view. The shutter glasses 20 include a left-eye lens 21L and a right-eye lens 21R. To the left-eye lens 21L and the right-eye lens 21R, light-blocking shutters (not shown) for light-blocking an opening part are respectively provided. The light-blocking shutters are liquid crystal shutters, for example. An effective state (that is, a closing state) and an ineffective state (that is, an opening state) of a light-blocking function of these light-blocking shutters are controlled by the control signal CTL supplied from the shutter control unit 14.

The shutter control unit 14 controls the light-blocking shutters of the shutter glasses 20 so that the opening state and the closing state of each of the left-eye lens 21L and the right-eye lens 21R are alternately switched in a manner to correspond to each display period of the left-eye video image L and the right-eye video image R. Specifically, the shutter control unit 14 performs control so as to make the light-blocking shutter of the left-eye lens 21L be in the opening state and make the light-blocking shutter of the right-eye lens 21R be in the closing state in the L sub-frame period, and so as to make the light-blocking shutter of the right-eye lens 21R be in the opening state and make the light-blocking shutter of the left-eye lens 21L be in the closing state in the R sub-frame period.

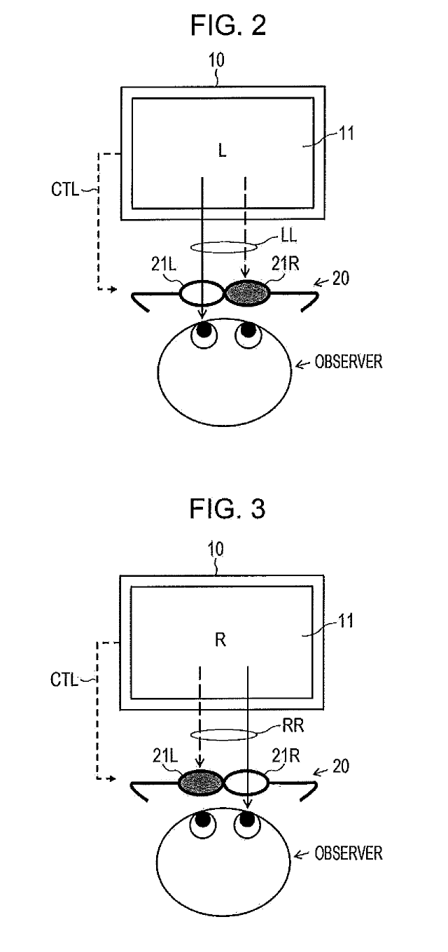

FIG. 2 illustrates a control operation of the shutter glasses 20 in the L sub-frame period. As shown in FIG. 2, in the L sub-frame period, the shutter of the left-eye lens 21L is set to be in the opening state and the shutter of the right-eye lens 21R is set to be in the closing state in accordance with the control signal CTL from the shutter control unit 14. Thus, display light LL based on the left-eye video image L passes only through the left-eye lens 21L. FIG. 3 illustrates a control operation of the shutter glasses 20 in the R sub-frame period. As shown in FIG. 3, in the R sub-frame period, the shutter of the right-eye lens 21R is set to be in the opening state and the shutter of the left-eye lens 21L is set to be in the closing state in accordance with the control signal CTL from the shutter control unit 14. Thus, display light RR based on the right-eye video image R passes only through the right-eye lens 21R.

In the stereoscopic video image display system 1 shown in FIG. 1, the video signal processing unit 13 corrects brightness difference and contrasts of respective left-eye video image and right-eye video image as described above.

For example, such method that contrast correction is performed by using a gamma curve produced on the basis of a measurement result of an APL of an image is widespread. However, when the contrast correction is performed by using average brightness of the whole screen, it is concerned that a correction amount of the whole screen affects brightness difference of a part of objects displayed on the screen, thus adversely affecting stereoscopic view, that is, correcting also a part on which images of left and right are normally different from each other.

Therefore, in the embodiment, correction of brightness difference and contrast correction are performed on a background region, which affects a flicker effect, of a stereoscopic video image in a concentrated manner without correcting an edge part which affects parallax, so as not to adversely affect a stereoscopic effect.

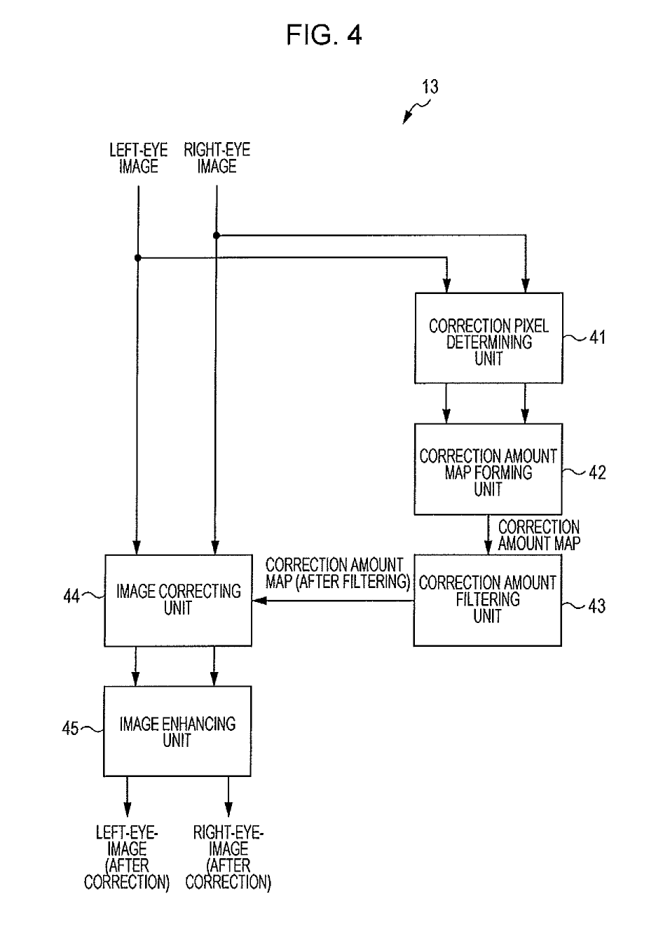

FIG. 4 schematically illustrates the functional configuration for correcting brightness difference and contrast of a stereoscopic video image in the video signal processing unit 13. As shown in FIG. 4, the video signal processing unit 13 includes a correction pixel determining unit 41, a correction amount map forming unit 42, a correction amount filtering unit 43, an image correcting unit 44, and an image enhancing unit 45.

When the left-eye image and the right-eye image are inputted, the correction pixel determining unit 41 detects an edge and a background region and determines a pixel to which correction is performed.

The correction amount map forming unit 42 calculates a correction amount of each pixel based on whether the pixel is determined as a correction pixel, so as to form a correction amount map of a screen.

The correction amount filtering unit 43 applies a low pass filter (LPF) to the correction amount map so as to prevent discontinuous change of the correction amount.

The image correcting unit 44 adds the correction amount map to each of the inputted left-eye image and right-eye image so as to obtain a correction image.

The image enhancing unit 45 gives enhancement such as edge enhancement to the left-eye image and the right-eye image which are corrected by the image correcting unit 44, so as to correct blur.

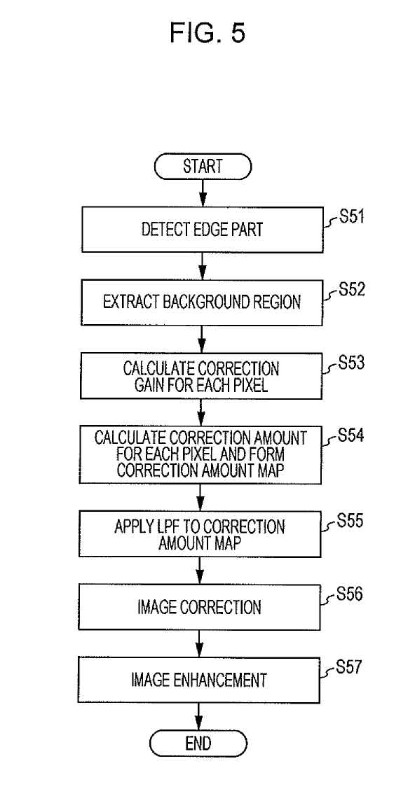

FIG. 5 is a flowchart of a processing procedure for correcting brightness difference and contrast of a stereoscopic video image in the video signal processing unit 13.

First, the correction pixel determining unit 41 detects an edge part of an input image (step S51). A left-eye image and a right-eye image are images having parallax. Thus, edge parts are not matched, so that an edge part can be detected by detecting brightness difference between the left-eye image and the right-eye image. When brightness difference between the left-eye image and the right-eye image is larger than a predetermined threshold value, the correction pixel determining unit 41 determines that a part in which brightness difference between the left-eye image and the right-eye image is larger than a predetermined threshold value is an edge part.

Then, the correction pixel determining unit 41 detects a background region of the input image (step S52). The background region commonly has small brightness change in a time direction. Accordingly, the correction pixel determining unit 41 performs measurement from several frames to dozens of frames and determines a region having small change as a background region. Here, when the whole screen is changed such as a scene change, past records are reset and measurement is restarted.

Subsequently, the correction pixel determining unit 41 determines a correction gain of each pixel by using results of steps S51 and S52 described above (step S53). In order to maintain parallax in the edge part, a correction gain is set to be small or correction is not performed on the edge part.

Then, the correction amount map forming unit 42 compares brightness of the left-eye image and brightness of the right-eye image so as to calculate a correction amount (step S54). For example, the correction amount map forming unit 42 calculates difference between the brightness of the left-eye image and the brightness of the right-eye image and multiplies the difference by the correction gain determined in step S53 so as to form a correction amount map. Here, in the calculation of brightness difference, a referential image (that is, a correction direction) such as a left-eye image, a right-eye image, a darker image, a brighter image, and average brightness can be selected.

The correction amount map formed by the correction amount map forming unit 42 includes a discontinuous part. Therefore, the correction amount filtering unit 43 applies a low pass filter with respect to the correction amount map so as to smooth the map (step S55). Here, the correction amount filtering unit 43 applies not only a two-dimensional low pass filter which is applied to the inside of the screen but also a low pass filter for preventing rapid change in the time direction.

Subsequently, the image correcting unit 44 adds the correction amount map obtained in step S55 to an input image (one of or both of the left-eye image and the right-eye image) (step S56) so as to obtain a correction image.

Since the low pass filter is applied to the correction amount map in step S55, an image after corrected in step S56 is slightly blurred. Therefore, the image enhancing unit 45 performs enhancement processing such as edge enhancement with respect to the correction image (step S57) so as to correct the blur.

According to the embodiment, flicker between a left-eye image and a right-eye image is reduced by correcting brightness difference and contrast of a stereoscopic video image, being able to improve image quality. Further, by reducing flicker between the left-eye image and the right-eye image, an image which is easily viewed three-dimensionally is obtained.

According to the embodiment, a correction amount is determined for every pixel, so that brightness difference correction processing and contrast correction processing can be performed without being affected by a shooting object's illuminated way or reflection.

Further, according to the embodiment, brightness difference and contrast of a left-eye image and a right-eye image are corrected on a background region in a concentrated manner while avoiding correcting an edge part which affects parallax. That is, the correction amount of the edge part of an object is reduced, thereby less affecting the illuminated way. Therefore, even though contrast correction is performed, an influence on a stereoscopic view is small. Consequently, a flicker effect can be eliminated without adversely affecting the stereoscopic effect.

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing apparatus, comprising:
a correction pixel determining unit configured to detect an edge and a background region of a left-eye image and a right-eye image so as to determine a pixel that is to be corrected;
a correction amount map forming unit configured to calculate a correction amount for each pixel based on whether the pixel is determined as a correction pixel, so as to form a correction amount map of a screen; and
an image correcting unit configured to add the correction amount map to each of the left-eye image and the right-eye image that are inputted, so as to obtain a correction image.

2. The video signal processing apparatus according to claim 1, further comprising:
a correction amount filtering unit configured to apply a low pass filter to the correction amount map formed by the correction amount map forming unit; wherein
the image correcting unit uses the correction amount map obtained after applying the low pass filter.

3. The video signal processing apparatus according to claim 2, wherein the correction amount filtering unit includes at least one of a two-dimensional low pass filter that is applied to an inside of the screen and a low pass filter that is applied in a time direction.

4. The video signal processing apparatus according to claim 1, further comprising:
an image enhancing unit configured to give enhancement to the left-eye image and the right-eye image that are obtained after corrected by the image correcting unit.

5. The video signal processing apparatus according to claim 1, wherein the correction pixel determining unit calculates brightness difference between the left-eye image and the right-eye image, and when the brightness difference is larger than a predetermined threshold value, the correction pixel determining unit determines that a part on which the brightness difference is larger than the predetermined threshold value is an edge part.

6. The video signal processing apparatus according to claim 1, wherein the correction pixel determining unit performs measurement for a predetermined number of frames and determines a region having small change as the background region.

7. The video signal processing apparatus according to claim 1, wherein the correction pixel determining unit decreases a correction gain on the edge part and increases a correction gain of the background region.

8. The video signal processing apparatus according to claim 1, wherein the correction amount map forming unit calculates difference between brightness of the left-eye image and brightness of the right-eye image and multiplies the difference by the correction gain determined by the correction pixel determining unit so as to obtain a correction amount.

9. A video signal processing method, comprising:
detecting an edge and a background region of a left-eye image and a right-eye image so as to determine a pixel that is to be corrected;
calculating a correction amount for each pixel based on whether the pixel is determined as a correction pixel, so as to form a correction amount map of a screen; and
adding the correction amount map to each of the left-eye image and the right-eye image that are inputted, so as to obtain a correction image.

10. A computer program that is written in a computer readable form and makes a computer execute a process comprising:
detecting an edge and a background region of a left-eye image and a right-eye image so as to determine a pixel that is to be corrected;
calculating a correction amount for each pixel based on whether the pixel is determined as a correction pixel, so as to form a correction amount map of a screen; and
adding the correction amount map to each of the left-eye image and the right-eye image that are inputted, so as to obtain a correction image.
